(19) United States
(12) Patent Application Publication
(10) Pub. No.: US 2023/0128847 A1
(43) Pub. Date: Apr. 27, 2023

(54) EFFICIENT SCG ACTIVATION AND DEACTIVATION AND MAINTAINING UPLINK TIMING ALIGNMENT WITH A SECONDARY NODE

(71) Applicant: QUALCOMM Incorporated, San Diego, CA (US)

(72) Inventors: Punyaslok PURKAYASTHA, San Diego, CA (US); Ravi AGARWAL, San Diego, CA (US); Gavin Bernard HORN, La Jolla, CA (US); Ozcan OZTURK, San Diego, CA (US); Peng CHENG, Beijing (CN); Huilin XU, Temecula, CA (US)

(21) Appl. No.: 17/905,397

(22) PCT Filed: Apr. 1, 2020
(86) PCT No.: PCT/CN2020/082750

§ 371 Date: Aug. 31, 2022

(51) Int. Cl. H04W 56/00; H04W 74/08; H04W 24/10; H04W 72/231

(52) U.S. Cl. CPC H04W 56/0045; H04W 56/0015; H04W 74/0833; H04W 24/10; H04W 72/231; H04W 88/06

(57) ABSTRACT

Aspects of the present disclosure relate to wireless communications, and more particularly, to mechanisms for maintaining timing alignment between a user equipment (UE) and a secondary cell group (SCG), which may help the UE may quick and efficient transitions from a dormant or de-active state in the SCG to an active state.

### TECHNICAL FIELD

Aspects of the present disclosure relate to wireless communications, and more particularly, to mechanisms for maintaining timing alignment between a user equipment (UE) and a secondary cell group (SCG).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

In some examples, a wireless multiple-access communication system may include a number of base stations, each simultaneously supporting communication for multiple communication devices, otherwise known as user equipment (UEs). In a Long Term Evolution (LTE) or LTE Advanced (LTE-A) network, a set of one or more base stations may define an eNodeB (eNB). In other examples (e.g., in a next generation or 5G network), a wireless multiple access communication system may include a number of distributed units (DUs) (e.g., edge units (EUs), edge nodes (ENs), radio heads (RHs), smart radio heads (SRHs), transmission reception points (TRPs), etc.) in communication with a number of central units (CUs) (e.g., central nodes (CNs), access node controllers (ANCs), etc.), where a set of one or more distributed units, in communication with a central unit, may define an access node (e.g., a new radio base station (NR BS), a new radio node-B (NR NB), a network node, 5G NB, gNB, gNodeB, etc.). A base station or DU may communicate with a set of UEs on downlink channels (e.g., for transmissions from a base station or to a UE) and uplink channels (e.g., for transmissions from a UE to a base station or distributed unit).

These multiple access technologies have been adopted in various telecommunication standards to provide a common protocol that enables different wireless devices to communicate on a municipal, national, regional, and even global level. An example of an emerging telecommunication standard is new radio (NR), for example, 5G radio access. NR is a set of enhancements to the LTE mobile standard promulgated by Third Generation Partnership Project (3GPP). It is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL) as well as support beamforming, multiple-input multiple-output (MIMO) antenna technology, and carrier aggregation.

However, as the demand for mobile broadband access continues to increase, there exists a need for further improvements in NR technology. For example, in multi-RAT Dual Connectivity (MR-DC) configurations, a UE may be desired to enter a non-activated state in relation to the network to reduce power consumption. This objective may conflict with the desire to maintain a timing alignment with the network such that the UE may quickly return to the activated state. There is a need to resolve such conflict. Preferably, the improvements in NR technology resolving the example problem mentioned should be applicable to other multi-access technologies and the telecommunication standards that employ these technologies.

### SUMMARY

Aspects of the present disclosure relate to wireless communications, and more particularly, to detecting data inactivity and expediting recovery action.

Certain aspects of the present disclosure provide a method for wireless communication by a UE. The method generally includes receiving an indication to establish uplink timing alignment with at least one secondary node (SN) of a secondary cell group (SCG) of a multi radio access technology (multi-RAT) dual configuration (MR-DC) configuration when the UE is operating in at least one of an SCG deactivated state or an SCG dormant state, determining whether the UE is in uplink timing alignment with the SN, and taking one or more actions, upon a determination that the UE is not in uplink timing alignment with the SN, to achieve uplink timing alignment with the SN.

Certain aspects of the present disclosure provide a method for wireless communication by a network entity configured as a secondary node (SN) of a secondary cell group (SCG) of a multi radio access technology (multi-RAT) dual configuration (MR-DC) configuration for a user equipment (UE). The method generally includes configuring the UE with a timing alignment timer for the UE to use to determine a time duration for which UE does not maintain UL timing with the SN when operating in an SCG deactivated state and entering the SCG deactivated state or an SCG dormant state.

Certain aspects of the present disclosure provide a method for wireless communication by a network entity configured as a master (MN) of a master cell group (MCG) of a multi radio access technology (multi-RAT) dual configuration (MR-DC) configuration for a user equipment (UE) The method generally includes receiving a configuration of a timing alignment timer for the UE to use to determine a time duration for which UE does not maintain UL timing with a secondary node (SN) of a secondary cell group (SCG) when the UE is operating in a deactivated state with the UE and configuring the UE with the timing alignment timer.

Aspects generally include methods, apparatus, systems, computer readable mediums, and processing systems, as substantially described herein with reference to and as illustrated by the accompanying drawings.

Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a block diagram conceptually illustrating an example telecommunications system, in accordance with certain aspects of the present disclosure.

FIG. 2 is a block diagram illustrating an example logical architecture of a distributed RAN, in accordance with certain aspects of the present disclosure.

FIG. 3 is a diagram illustrating an example physical architecture of a distributed RAN, in accordance with certain aspects of the present disclosure.

FIG. 4 is a block diagram conceptually illustrating a design of an example BS and UE, in accordance with certain aspects of the present disclosure.

FIG. 5 is a diagram showing examples for implementing a communication protocol stack, in accordance with certain aspects of the present disclosure.

FIG. 6 illustrates an example of a frame format for a new radio (NR) system, in accordance with certain aspects of the present disclosure.

FIG. 7 illustrates example operations for wireless communications by a user equipment (UE), in accordance with aspects of the present disclosure.

FIG. 8 illustrates example operations for wireless communications by a secondary node (SN), in accordance with aspects of the present disclosure.

FIG. 9 illustrates example operations for wireless communications by a master node (MN), in accordance with aspects of the present disclosure.

FIG. 10 is a call flow diagram illustrating an example of a UE maintaining timing alignment in an SCG de-activated state, in accordance with aspects of the present disclosure

FIG. 11 is a call flow diagram illustrating an example of a UE maintaining timing alignment in an SCG dormant state, in accordance with aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure relate to wireless communications, and more particularly, to mechanisms for maintaining timing alignment between a user equipment (UE) and a secondary cell group (SCG). As will be described in greater detail below, such mechanisms may allow for quick and efficient transitions of a UE from a dormant or de-active state in an SCG to an active state.

Aspects of the present disclosure provide apparatus, methods, processing systems, and computer readable mediums for new radio (NR) (new radio access technology or 5G technology).

NR may support various wireless communication services, such as Enhanced mobile broadband (eMBB) targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra-reliable low latency communications (URLLC). These services may include latency and reliability requirements. These services may also have different transmission time intervals (TTI) to meet respective quality of service (QoS) requirements. In addition, these services may co-exist in the same subframe.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

The techniques described herein may be used for various wireless communication networks such as LTE, CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). NR is an emerging wireless communications technology under development in conjunction with the 5G Technology Forum (SGTF). 3GPP Long Term Evolution (LTE) and LTE-Advanced (LTE-A) are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, while aspects may be described herein using terminology commonly associated with 3G and/or 4G wireless technologies, aspects of the present disclosure can be applied in other generation-based communication systems, such as 5G and later, including NR technologies.

### Example Wireless System

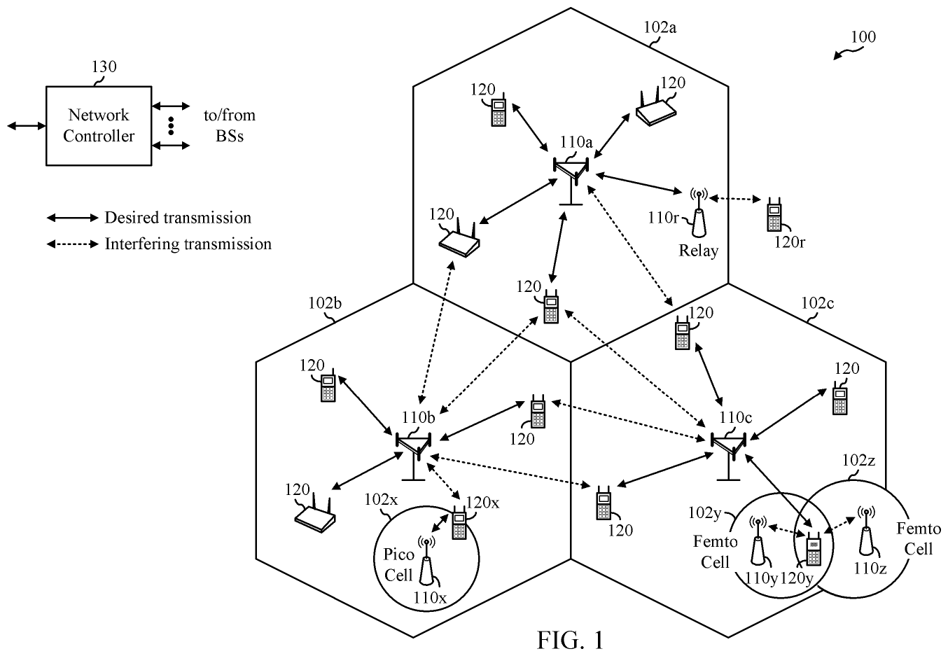

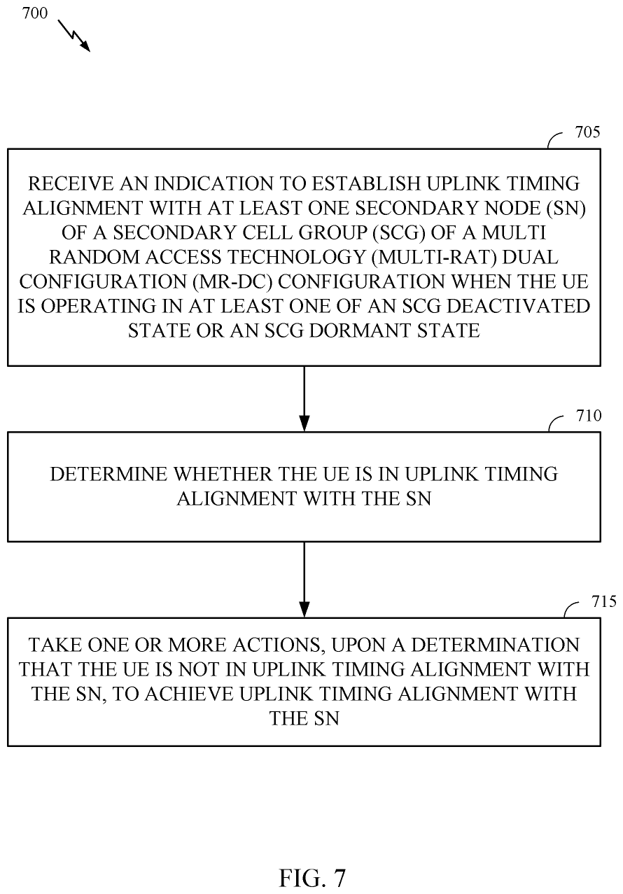

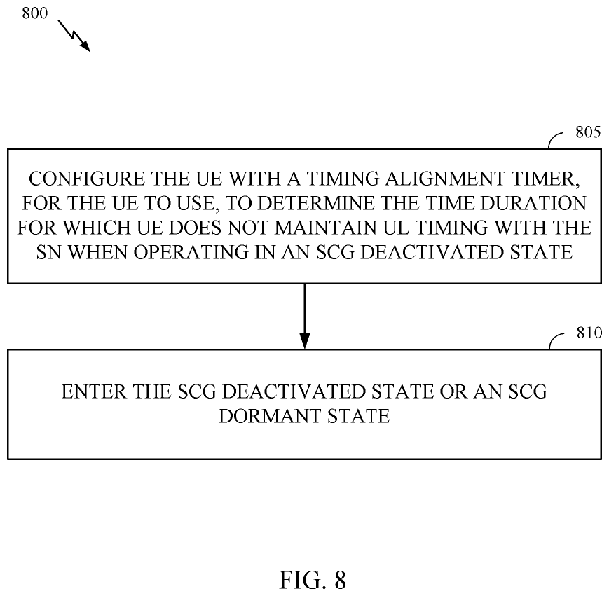

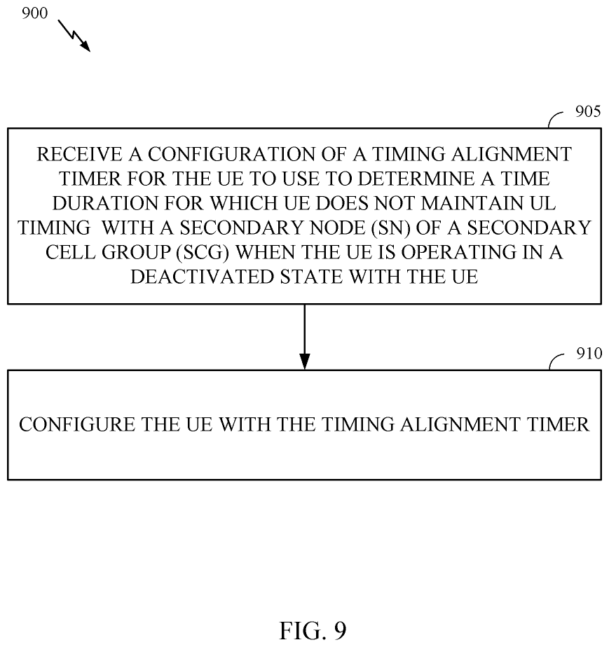

FIG. 1 illustrates an example wireless network 100 in which aspects of the present disclosure may be performed. For example, one or more UEs 120 of the wireless network 100 may be configured to perform operations 700 of FIG. 7 to maintain uplink timing alignment with a secondary node (SN) of a secondary cell group (SCG). Similarly, one or more base stations 110, acting as the SN or a master node (MN) of a master cell group (MCG) may be configured to perform operations 800 of FIG. 8 and/or operations 900 of FIG. 9 to configure and/or assist a UE in maintaining uplink timing alignment with the SN.

As illustrated in FIG. 1, the wireless network 100 may include a number of BSs 110 and other network entities. A BS may be a station that communicates with UEs. Each BS 110 may provide communication coverage for a particular geographic area. In 3GPP, the term “cell” can refer to a coverage area of a Node B and/or a Node B subsystem serving this coverage area, depending on the context in which the term is used. In NR systems, the term “cell” and gNB, Node B, 5G NB, AP, NR BS, NR BS, or TRP may be interchangeable. In some examples, a cell may not necessarily be stationary, and the geographic area of the cell may move according to the location of a mobile base station. In some examples, the base stations may be interconnected to one another and/or to one or more other base stations or network nodes (not shown) in the wireless network 100 through various types of backhaul interfaces such as a direct physical connection, a virtual network, or the like using any suitable transport network.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a frequency channel, etc. Each frequency may support a single RAT in a given geographic area in order to avoid interference between wireless networks of different RATs. In some cases, NR or 5G RAT networks may be deployed.

A BS may provide communication coverage for a macro cell, a pico cell, a femto cell, and/or other types of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a Closed Subscriber Group (CSG), UEs for users in the home, etc.). ABS for a macro cell may be referred to as a macro BS. ABS for a pico cell may be referred to as a pico BS. ABS for a femto cell may be referred to as a femto BS or a home BS. In the example shown in FIG. 1, the BSs 110a, 110b and 110c may be macro BSs for the macro cells 102a, 102b and 102c, respectively. The BS 110x may be a pico BS fora pico cell 102x. The BSs 110y and 110z may be femto BS for the femto cells 102y and 102z, respectively. ABS may support one or multiple (e.g., three) cells.

The wireless network 100 may also include relay stations. A relay station is a station that receives a transmission of data and/or other information from an upstream station (e.g., a BS or a UE) and sends a transmission of the data and/or other information to a downstream station (e.g., a UE or a BS). A relay station may also be a UE that relays transmissions for other UEs. In the example shown in FIG. 1, a relay station 110r may communicate with the BS 110a and a UE 120r to facilitate communication between the BS 110a and the UE 120r. A relay station may also be referred to as a relay BS, a relay, etc.

The wireless network 100 may be a heterogeneous network that includes BSs of different types, e.g., macro BS, pico BS, femto BS, relays, etc. These different types of BSs may have different transmit power levels, different coverage areas, and different impact on interference in the wireless network 100. For example, macro BS may have a high transmit power level (e.g., 20 Watts) whereas pico BS, femto BS, and relays may have a lower transmit power level (e.g., 1 Watt).

The wireless network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time. The techniques described herein may be used for both synchronous and asynchronous operation.

A network controller 130 may couple to a set of BSs and provide coordination and control for these BSs. The network controller 130 may communicate with the BSs 110 via a backhaul. The BSs 110 may also communicate with one another, e.g., directly or indirectly via wireless or wireline backhaul.

The UEs 120 (e.g., 120x, 120y, etc.) may be dispersed throughout the wireless network 100, and each UE may be stationary or mobile. A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered evolved or machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices.

In FIG. 1, a solid line with double arrows indicates desired transmissions between a UE and a serving BS, which is a BS designated to serve the UE on the downlink and/or uplink. A dashed line with double arrows indicates interfering transmissions between a UE and a BS.

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a ‘resource block’) may be 12 subcarriers (or 180 kHz). Consequently, the nominal FFT size may be equal to 128, 256, 512, 1024 or 2048 for system bandwidth of 1.25, 2.5, 5, 10 or 20 megahertz (MHz), respectively. The system bandwidth may also be partitioned into subbands. For example, a subband may cover 1.08 MHz (i.e., 6 resource blocks), and there may be 1, 2, 4, 8 or 16 subbands for system bandwidth of 1.25, 2.5, 5, 10 or 20 MHz, respectively.

While aspects of the examples described herein may be associated with LTE technologies, aspects of the present disclosure may be applicable with other wireless communications systems, such as NR.

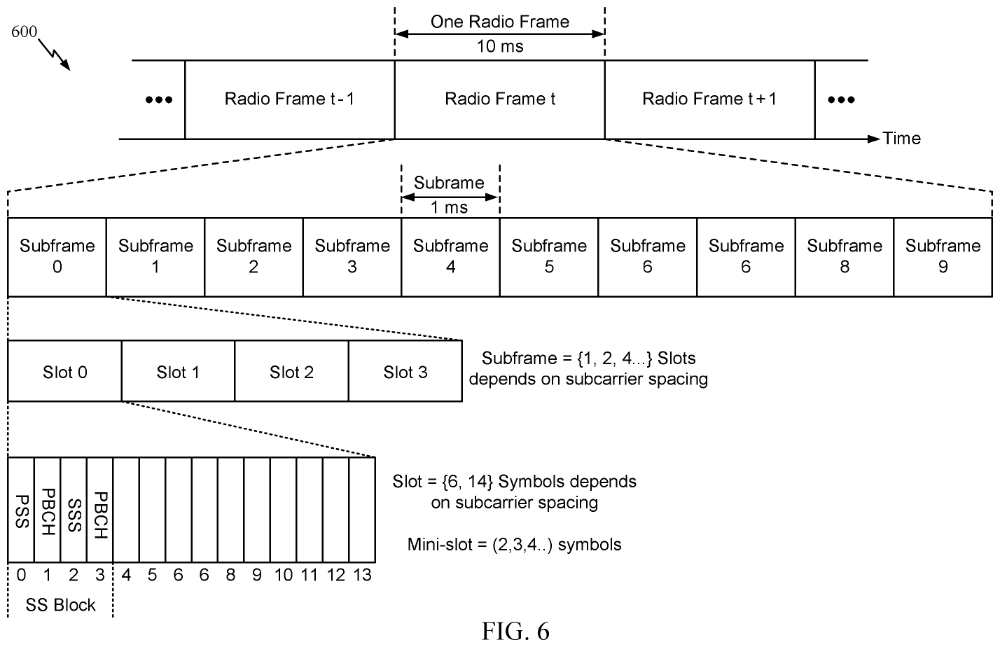

NR may utilize OFDM with a CP on the uplink and downlink and include support for half-duplex operation using TDD. A single component carrier bandwidth of 100 MHz may be supported. NR resource blocks may span 12 sub-carriers with a subcarrier bandwidth of 75 kHz over a 0.1 ms duration. In one aspect, each radio frame may consist of 50 subframes with a length of 10 ms. Consequently, each subframe may have a length of 0.2 ms. In another aspect, each radio frame may consist of 10 subframes with a length of 10 ms, where each subframe may have a length of 1 ms. Each subframe may indicate a link direction (i.e., DL or UL) for data transmission and the link direction for each subframe may be dynamically switched. Each subframe may include DL/UL data as well as DL/UL control data. UL and DL subframes for NR may be as described in more detail below with respect to FIGS. 6 and 7. Beamfoiining may be supported and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells. Alternatively, NR may support a different air interface, other than an OFDM-based. NR networks may include entities such CUs and/or DUs.

In some examples, access to the air interface may be scheduled, wherein a scheduling entity (e.g., a base station) allocates resources for communication among some or all devices and equipment within its service area or cell. Within the present disclosure, as discussed further below, the scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. That is, in some examples, a UE may function as a scheduling entity, scheduling resources for one or more subordinate entities (e.g., one or more other UEs). In this example, the UE is functioning as a scheduling entity, and other UEs utilize resources scheduled by the UE for wireless communication. A UE may function as a scheduling entity in a peer-to-peer (P2P) network, and/or in a mesh network. In a mesh network example, UEs may optionally communicate directly with one another in addition to communicating with the scheduling entity.

Thus, in a wireless communication network with a scheduled access to time-frequency resources and having a cellular configuration, a P2P configuration, and a mesh configuration, a scheduling entity and one or more subordinate entities may communicate utilizing the scheduled resources.

As noted above, a RAN may include a CU and DUs. A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity, but not used for initial access, cell selection/reselection, or handover. In some cases, DCells may not transmit synchronization signals—in some case cases DCells may transmit SS. NRBSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

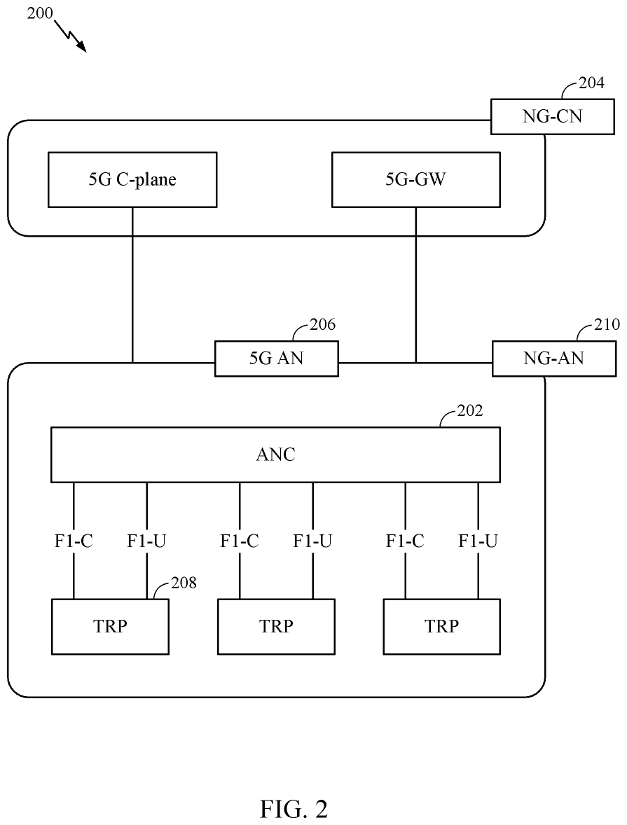

FIG. 2 illustrates an example logical architecture of a distributed radio access network (RAN) 200, which may be implemented in the wireless communication system illustrated in FIG. 1. A 5G access node 206 may include an access node controller (ANC) 202. The ANC may be a central unit (CU) of the distributed RAN 200. The backhaul interface to the next generation core network (NG-CN) 204 may terminate at the ANC. The backhaul interface to neighboring next generation access nodes (NG ANs) may terminate at the ANC. The ANC may include one or more TRPs 208 (which may also be referred to as BSs, NR BSs, Node Bs, 5G NBs, APs, or some other term). As described above, a TRP may be used interchangeably with “cell.”

The TRPs 208 may be a DU. The TRPs may be connected to one ANC (ANC 202) or more than one ANC (not illustrated). For example, for RAN sharing, radio as a service (RaaS), and service specific AND deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture 200 may be used to illustrate fronthaul definition. The architecture may be defined that support fronthauling solutions across different deployment types. For example, the architecture may be based on transmit network capabilities (e.g., bandwidth, latency, and/or jitter).

The architecture may share features and/or components with LTE. According to aspects, the next generation AN (NG-AN) 210 may support dual connectivity with NR. The NG-AN may share a common fronthaul for LTE and NR.

The architecture may enable cooperation between and among TRPs 208. For example, cooperation may be preset within a TRP and/or across TRPs via the ANC 202. According to aspects, no inter-TRP interface may be needed/present.

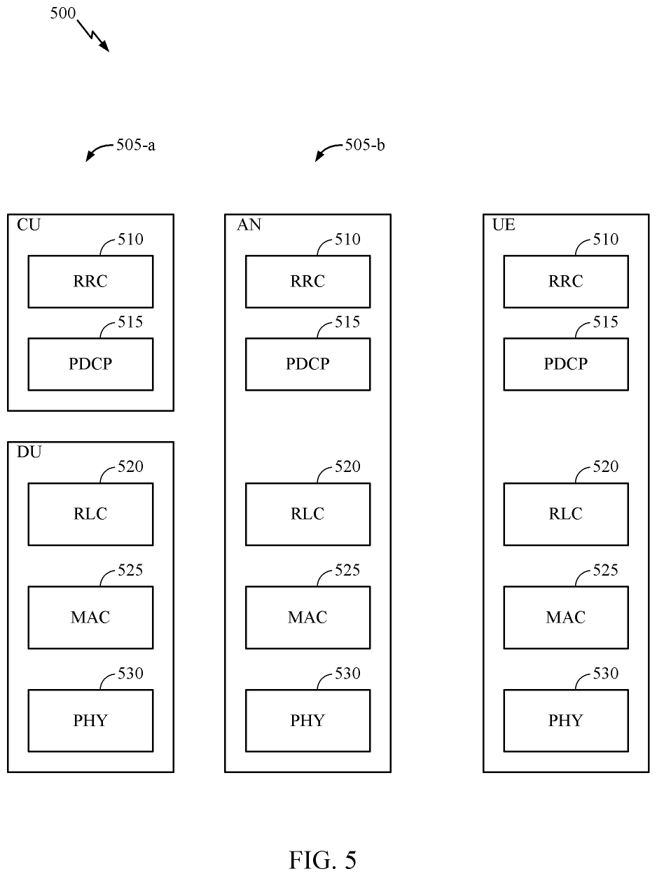

According to aspects, a dynamic configuration of split logical functions may be present within the architecture 200. As will be described in more detail with reference to FIG. 5, the Radio Resource Control (RRC) layer, Packet Data Convergence Protocol (PDCP) layer, Radio Link Control (RLC) layer, Medium Access Control (MAC) layer, and a Physical (PHY) layers may be adaptably placed at the DU or CU (e.g., TRP or ANC, respectively). According to certain aspects, a BS may include a central unit (CU) (e.g., ANC 202) and/or one or more distributed units (e.g., one or more TRPs 208).

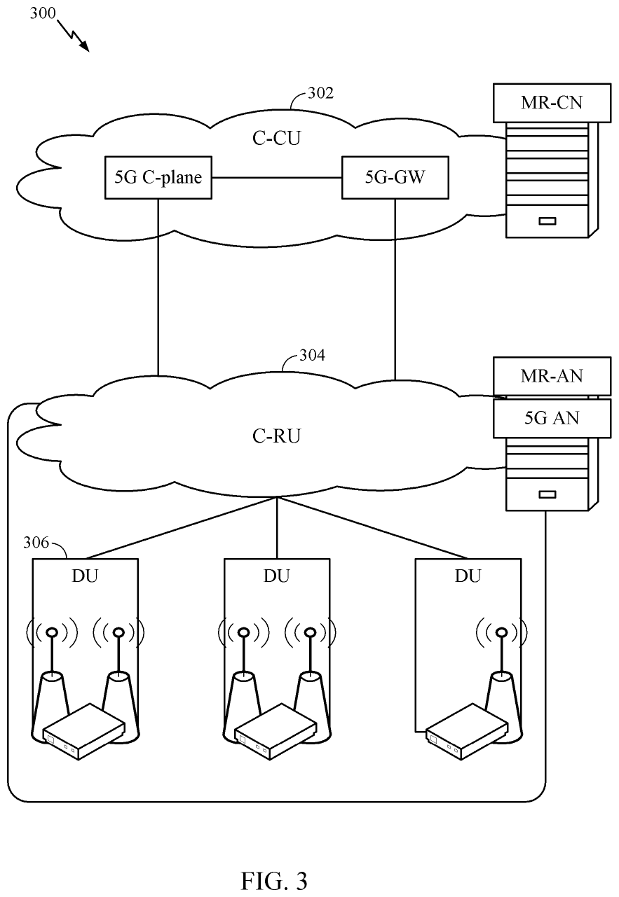

FIG. 3 illustrates an example physical architecture of a distributed RAN 300, according to aspects of the present disclosure. A centralized core network unit (C-CU) 302 may host core network functions. The C-CU may be centrally deployed. C-CU functionality may be offloaded (e.g., to advanced wireless services (AWS)), to handle peak capacity.

A centralized RAN unit (C-RU) 304 may host one or more ANC functions. Optionally, the C-RU may host core network functions locally. The C-RU may have distributed deployment. The C-RU may be closer to the network edge.

A DU 306 may host one or more TRPs (edge node (EN), an edge unit (EU), a radio head (RH), a smart radio head (SRH), or the like). The DU may be located at edges of the network with radio frequency (RF) functionality.

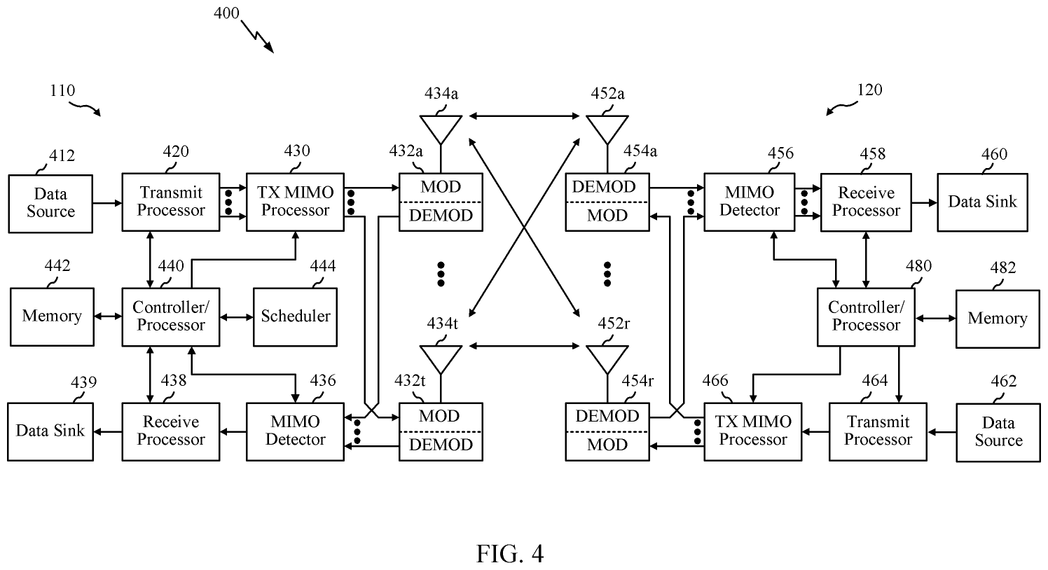

FIG. 4 illustrates example components of the BS 110 and UE 120 illustrated in FIG. 1, which may be used to implement aspects of the present disclosure. The BS may include a TRP or gNB.

According to an example, antennas 452, DEMOD/MOD 454, processors 466, 458, 464, and/or controller/processor 480 of the UE 120 may be used to perform the operations described herein and illustrated with reference to FIG. 8.

As an example, one or more of the antennas 452, DEMOD/MOD 454, processors 466, 458, 464, and/or controller/processor 480 of the UE 120 may be configured to perform operations 700 of FIG. 7. Similarly, controller/processor 440 of the BS 110 may be configured to perform operations 800 of FIG. 8 and/or operations 900 of FIG. 9.

For a restricted association scenario, the base station 110 may be the macro BS 110c in FIG. 1, and the UE 120 may be the UE 120y. The base station 110 may also be a base station of some other type. The base station 110 may be equipped with antennas 434a through 434t, and the UE 120 may be equipped with antennas 452a through 452r.

At the base station 110, a transmit processor 420 may receive data from a data source 412 and control information from a controller/processor 440. The control information may be for the Physical Broadcast Channel (PBCH), Physical Control Format Indicator Channel (PCFICH), Physical Hybrid ARQ Indicator Channel (PHICH), Physical Downlink Control Channel (PDCCH), etc. The data may be for the Physical Downlink Shared Channel (PDSCH), etc. The processor 420 may process (e.g., encode and symbol map) the data and control information to obtain data symbols and control symbols, respectively. The processor 420 may also generate reference symbols, e.g., for the PSS, SSS, and cell-specific reference signal (CRS). A transmit (TX) multiple-input multiple-output (MIMO) processor 430 may perform spatial processing (e.g., precoding) on the data symbols, the control symbols, and/or the reference symbols, if applicable, and may provide output symbol streams to the modulators (MODs) 432a through 432t. Each modulator 432 may process a respective output symbol stream (e.g., for OFDM, etc.) to obtain an output sample stream. Each modulator 432 may further process (e.g., convert to analog, amplify, filter, and upconvert) the output sample stream to obtain a downlink signal. Downlink signals from modulators 432a through 432t may be transmitted via the antennas 434a through 434t, respectively.

At the UE 120, the antennas 452a through 452r may receive the downlink signals from the base station 110 and may provide received signals to the demodulators (DEMODs) 454a through 454r, respectively. Each demodulator 454 may condition (e.g., filter, amplify, downconvert, and digitize) a respective received signal to obtain input samples. Each demodulator 454 may further process the input samples (e.g., for OFDM, etc.) to obtain received symbols. A MIMO detector 456 may obtain received symbols from all the demodulators 454a through 454r, perform MIMO detection on the received symbols if applicable, and provide detected symbols. A receive processor 458 may process (e.g., demodulate, deinterleave, and decode) the detected symbols, provide decoded data for the UE 120 to a data sink 460, and provide decoded control information to a controller/processor 480.

On the uplink, at the UE 120, a transmit processor 464 may receive and process data (e.g., for the Physical Uplink Shared Channel (PUSCH)) from a data source 462 and control information (e.g., for the Physical Uplink Control Channel (PUCCH) from the controller/processor 480. The transmit processor 464 may also generate reference symbols for a reference signal. The symbols from the transmit processor 464 may be precoded by a TX MIMO processor 466 if applicable, further processed by the demodulators 454a through 454r (e.g., for SC-FDM, etc.), and transmitted to the base station 110. At the BS 110, the uplink signals from the UE 120 may be received by the antennas 434, processed by the modulators 432, detected by a MIMO detector 436 if applicable, and further processed by a receive processor 438 to obtain decoded data and control information sent by the UE 120. The receive processor 438 may provide the decoded data to a data sink 439 and the decoded control information to the controller/processor 440.

The controllers/processors 440 and 480 may direct the operation at the base station 110 and the UE 120, respectively. A scheduler 444 may schedule UEs for data transmission on the downlink and/or uplink. The processor 480 and/or other processors and modules at the UE 120 may perform or direct, e.g., the execution of the functional blocks illustrated in FIG. 7 and/or other processes for the techniques described herein and those illustrated in the appended drawings. The processor 440 and/or other processors and modules at the BS 110 may perform or direct processes for the techniques described with reference to FIG. 8 and/or FIG. 9 and/or other processes for the techniques described herein and those illustrated in the appended drawings. The memories 442 and 482 may store data and program codes for the BS 110 and the UE 120, respectively.

FIG. 5 illustrates a diagram 500 showing examples for implementing a communications protocol stack, according to aspects of the present disclosure. The illustrated communications protocol stacks may be implemented by devices operating in a 5G system. Diagram 500 illustrates a communications protocol stack including a Radio Resource Control (RRC) layer 510, a Packet Data Convergence Protocol (PDCP) layer 515, a Radio Link Control (RLC) layer 520, a Medium Access Control (MAC) layer 525, and a Physical (PHY) layer 530. In various examples the layers of a protocol stack may be implemented as separate modules of software, portions of a processor or ASIC, portions of non-collocated devices connected by a communications link, or various combinations thereof. Collocated and non-collocated implementations may be used, for example, in a protocol stack for a network access device (e.g., ANs, CUs, and/or DUs) or a UE.

A first option 505-a shows a split implementation of a protocol stack, in which implementation of the protocol stack is split between a centralized network access device (e.g., an ANC 202 in FIG. 2) and distributed network access device (e.g., DU 208 in FIG. 2). In the first option 505-a, an RRC layer 510 and a PDCP layer 515 may be implemented by the central unit, and an RLC layer 520, a MAC layer 525, and a PHY layer 530 may be implemented by the DU. In various examples the CU and the DU may be collocated or non-collocated. The first option 505-a may be useful in a macro cell, micro cell, or pico cell deployment.

A second option 505-b shows a unified implementation of a protocol stack, in which the protocol stack is implemented in a single network access device (e.g., access node (AN), new radio base station (NR BS), a new radio Node-B (NR NB), a network node (NN), or the like.). In the second option, the RRC layer 510, the PDCP layer 515, the RLC layer 520, the MAC layer 525, and the PHY layer 530 may each be implemented by the AN. The second option 505-b may be useful in a femto cell deployment.

Regardless of whether a network access device implements part or all of a protocol stack, a UE may implement an entire protocol stack (e.g., the RRC layer 510, the PDCP layer 515, the RLC layer 520, the MAC layer 525, and the PHY layer 530).

FIG. 6 is a diagram showing an example of a frame format 600 for NR. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots depending on the subcarrier spacing. Each slot may include a variable number of symbol periods (e.g., 7 or 14 symbols) depending on the subcarrier spacing. The symbol periods in each slot may be assigned indices. A mini-slot, which may be referred to as a sub-slot structure, refers to a transmit time interval having a duration less than a slot (e.g., 2, 3, or 4 symbols).

Each symbol in a slot may indicate a link direction (e.g., DL, UL, or flexible) for data transmission and the link direction for each subframe may be dynamically switched. The link directions may be based on the slot format. Each slot may include DL/UL data as well as DL/UL control information.

In NR, a synchronization signal (SS) block is transmitted. The SS block includes a PSS, a SSS, and a two symbol PBCH. The SS block can be transmitted in a fixed slot location, such as the symbols 0-3 as shown in FIG. 6. The PSS and SSS may be used by UEs for cell search and acquisition. The PSS may provide half-frame timing, the SS may provide the CP length and frame timing. The PSS and SSS may provide the cell identity. The PBCH carries some basic system information, such as downlink system bandwidth, timing information within radio frame, SS burst set periodicity, system frame number, etc. The SS blocks may be organized into SS bursts to support beam sweeping. Further system information such as, remaining minimum system information (RMSI), system information blocks (SIBs), other system information (OSI) can be transmitted on a physical downlink shared channel (PDSCH) in certain subframes.

A UE may operate in various radio resource configurations, including a configuration associated with transmitting pilots using a dedicated set of resources (e.g., a radio resource control (RRC) dedicated state, etc.) or a configuration associated with transmitting pilots using a common set of resources (e.g., an RRC common state, etc.). When operating in the RRC dedicated state, the UE may select a dedicated set of resources for transmitting a pilot signal to a network. When operating in the RRC common state, the UE may select a common set of resources for transmitting a pilot signal to the network. In either case, a pilot signal transmitted by the UE may be received by one or more network access devices, such as an AN, or a DU, or portions thereof. Each receiving network access device may be configured to receive and measure pilot signals transmitted on the common set of resources, and also receive and measure pilot signals transmitted on dedicated sets of resources allocated to the UEs for which the network access device is a member of a monitoring set of network access devices for the UE. One or more of the receiving network access devices, or a CU to which receiving network access device(s) transmit the measurements of the pilot signals, may use the measurements to identify serving cells for the UEs, or to initiate a change of serving cell for one or more of the UEs.

### Example UE Timing Alignment in SCG Non Activated States

Aspects of the present disclosure provide methods and mechanisms for maintaining a timing alignment between an UE and an SN of an SCG, when the UE is operating in an SCG non-activated state, such as an SCG deactivated state or an SCG dormant state. Maintaining uplink timing alignment in this manner may allow for a quick transition from the deactivated state or dormant state to an activated state, which may help improve overall system performance and user experience by enabling the UE to start or resume transmissions on the UL as soon as possible.

In some cases, the techniques presented herein may essentially utilize various activation and deactivation states that are analogous to those used for secondary cells (SCells) of a master cell group (MCG) or an SCG. For example, the present disclosure proposes activated, deactivated, and dormant SCG states, for a PSCell (a primary SCell of an SCG).

In the SCG activated state, data transfer (UL, DL) may take place between the UE and SCG. In the SCG deactivated state, there may be no data transfer, the UE does not monitor for PDCCH, and the UE does not provide (SCG) CQI reports to the network. In the SCG dormant state, there may be no data transfer and the UE does not monitor for PDCCH, but the UE performs CQI measurements and may provide CQI measurement reports.

By helping a UE maintain uplink timing alignment in the SCG, aspects of the present disclosure, may provide flexibility and help achieve a trade-off between power consumption (in the deactivated and dormant states) and delay in transition from either state to an activated state.

In some cases, a UE may be configured to perform radio resource management (RRM) measurements on the SCG, in SCG deactivated and dormant states, and report those measurements to help ensure coverage. In the dormant state, since the UE may already perform CQI reporting, RRM measurements and reporting may not add significantly to power consumption. The UE may be configured (by a master node of an MCG) to perform measurements and send the reports over SRB1 (signaling radio bearer 1). The UE may also performs SN configured measurements and sends reports over SRB1 or SRB3, if SRB3 is configured. If reports are transmitted over SRB3, UL timing with the SN may need to be maintained (to help ensure the reports can be received).

In some cases, the MN transmits PSCell change or SN change commands (RRC reconfiguration) in response to the measurement reports, if required. Because RRM measurements may trigger PSCell changes before radio conditions deteriorate significantly, Radio link monitoring (RLM) measurements in SCG deactivated and dormant states may not be needed.

As will be described in greater detail below, there may be benefits to a UE performing channel quality indicator (CQI) measurements and periodic reporting of at least the SCG PSCell. There are various approaches for configuring a UE to send periodic CQI reports.

According to one approach, the network may configure PUCCH resources on the PSCell over which CQI reports may be sent. While this may require the UE to maintain UL timing with the SN in the dormant state, aspects of the present disclosure allow for such maintenance. According to another approach, the network may configure PUCCH resources on the PCell or a PUCCH SCell on the MCG. There may be issues with this approach. For example, in e-UTRA NR dual connectivity (EN-DC), next generation EN-DC (NGEN-DC), and NE-DC (where the master RAN is a 5G gNB and the secondary RAN node is a 4G ng-eNB), because the CQI report format for one RAT may be incompatible with PUCCH resources in the other RAT, even if carried as a bit string. This approach may work, however, in the NR-DC case (where both master and secondary are NR). This approach may also not require the UE to maintain UL timing alignment with the SN, although X2/Xn signaling may be required for the MN to forward received CQI reports to the SN (though the backhaul delay involved in forwarding may be tolerable, since there is no DL or UL data transfer and, hence, no scheduling).

As noted above, aspects of the present disclosure may provide techniques for maintain uplink timing alignment between a UE and an SN during SCG deactivated and dormant states. The techniques may help achieve a trade-off between power consumption due to SCG transmission and reception for maintaining UL timing and the delay associated with performing a random access channel (RACH) procedure on a SN, upon SCG activation.

FIG. 7 illustrates example operations 700 for wireless communications by a UE, in accordance with aspects of the present disclosure. Operations 700 may be performed, for example, by a UE 120 of FIG. 1 or 4 to maintain uplink timing alignment with an SN when operating in an SCG deactivated or dormant state.

Operations 700 begin, at 705, by receiving an indication to establish uplink timing alignment with at least one secondary node (SN) of a secondary cell group (SCG) of a multi radio access technology (multi-RAT) dual configuration (MR-DC) configuration when the UE is operating in at least one of an SCG deactivated state or an SCG dormant state.

The indication may be provided via signaling, that can originate from the MN or the SN and that is transmitted via the MCG to transition from the SCG deactivated state or SCG dormant state to an SCG activated state. Such signaling may be via a PDCCH DCI, in a MAC CE, or in a RRC Reconfiguration message. As an alternative, the indication may be provided via a timing advance command (TAC) from the SN, delivered via the MCG, when the UE is operating in the SCG dormant state.

At 710, the UE determines whether the UE is in uplink timing alignment with the SN. At 715, the UE takes one or more actions, upon a determination that the UE is not in uplink timing alignment with the SN, to achieve uplink timing alignment with the SN. For example, the UE may perform a RACH procedure on the SN to acquire UL timing based on the determination.

FIG. 8 illustrates example operations 800 for wireless communications by a secondary node (SN), in accordance with aspects of the present disclosure. For example, operations 800 may be performed by a base station 110 of FIG. 1 or FIG. 4 operating as an SN (e.g., a PSCell) of an SCG of an (MR-DC).

Operations 800 begin, at 805, by configuring the UE with a timing alignment timer for the UE to use to determine a time duration for which UE does not maintain UL timing with the SN when operating in an SCG deactivated state. At 810, the SN enters the SCG deactivated state or an SCG dormant state.

FIG. 9 illustrates example operations 900 for wireless communications by a master node (MN), in accordance with aspects of the present disclosure. For example, operations 900 may be performed by a base station 110 of FIG. 1 or FIG. 4 operating as a MN of an MCG of an (MR-DC).

Operations 900 begin, at 905, by receiving a configuration of a timing alignment timer for the UE to use to determine a time duration for which UE does not maintain UL timing with a secondary node (SN) of a secondary cell group (SCG) when the UE is operating in a deactivated state with the UE. At 910, the MN configures the UE with the timing alignment timer.

In some cases, the particular approach for a UE to maintain UL timing in SCG dormant or deactivated states may depend on whether the UE is in the SCG deactivated state or the SCG dormant state.

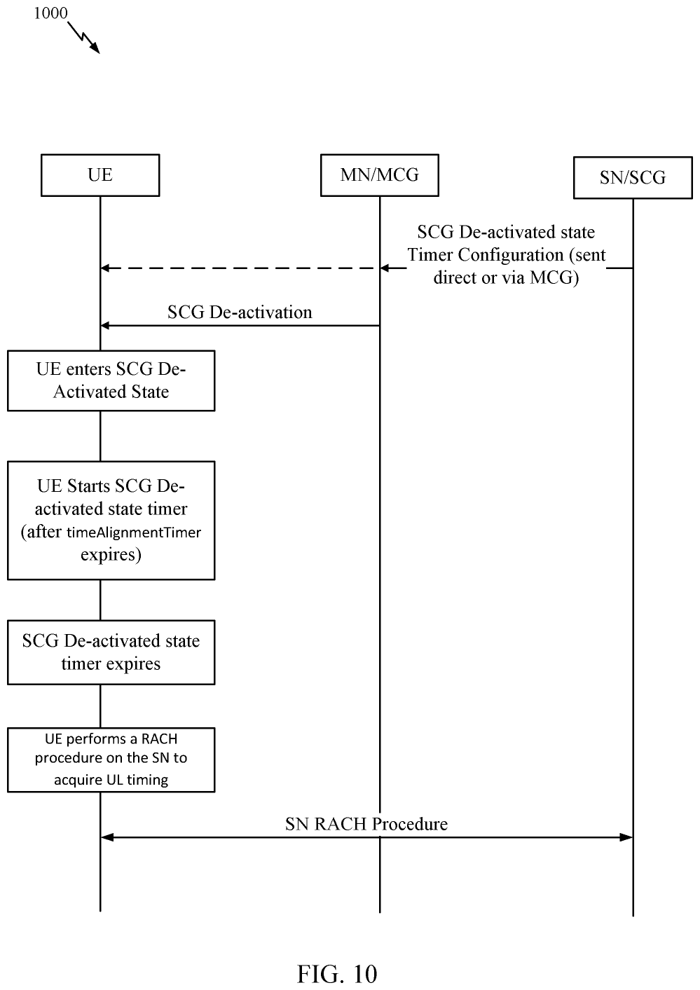

FIG. 10 is a call flow diagram that illustrates how a UE in an SCG deactivated state can maintain UL timing with the SN.

As illustrated, the UE may determine it is not in uplink timing alignment with the SN based on whether a configured timer has expired. In some cases, the UE may receive a timer configuration (e.g., for a new type of timer) for the SCG deactivated state in an RRC reconfiguration message transmitted by the SN, via the MCG, or in an RRC reconfiguration message transmitted by SN via the SCG.

In either case, the configured timer generally specifies the time duration for which UE does not maintain UL timing with the SN in SCG deactivated state. As illustrated, the configured timer may be started upon the UE determining a timeAlignmentTimer (e.g., which controls how long a MAC entity considers Serving Cells belonging to a timing adjustment group to be uplink time aligned) has expired. As illustrated, upon determining that the configured timer has expired, the UE may perform a RACH procedure on the SN to acquire UL timing.

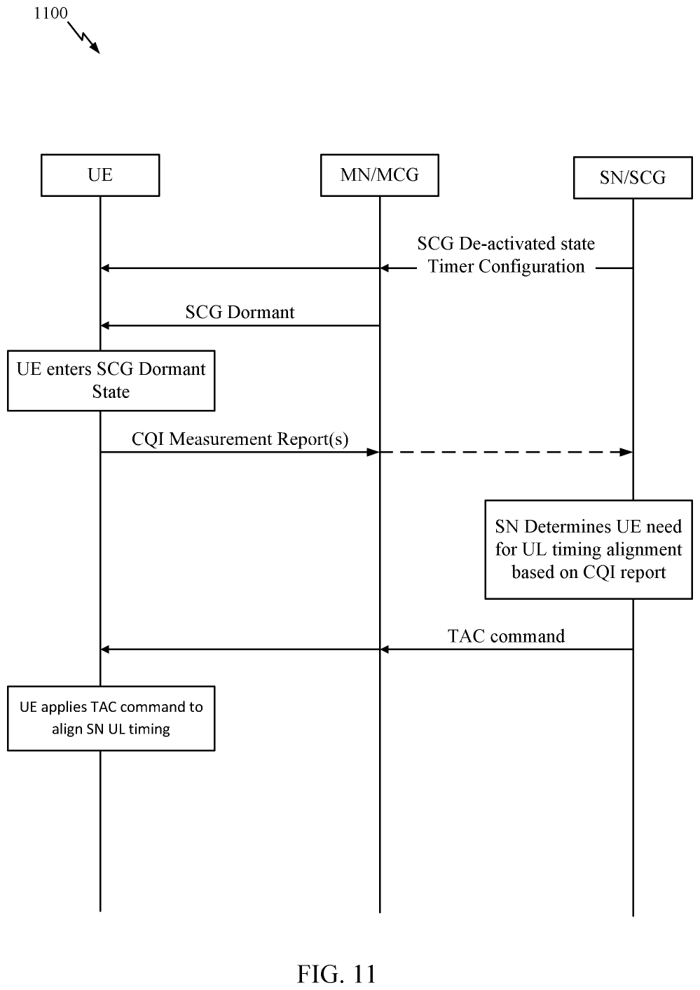

FIG. 11 is a call flow diagram that illustrates how a UE in an SCG dormant state can maintain UL timing with the SN.

As illustrated, in the SCG dormant state, the UE may send CQI measurement reports. According to one option, the UE periodically transmits the measurement reports on PSCell PUCCH (SCG) resources to enable the SN to detect UL timing misalignment. According to another option, the UE periodically transmits the measurement reports on MCG PUCCH resources and the MN forwards the received reports to the SN.

In either case, upon determining the need for UL timing alignment based on the measurement reports, the SN may send a timing adjust command (TAC) command to the UE to correct UL timing. This TAC command may need to be transmitted via the MCG because, in the SCG dormant state, the UE is not monitoring the PDCCH on SCG. The SN can send the TAC command to the UE in various ways. For example, the SN may send the TAC command in an SN RRC Reconfiguration message (contained within an RRC Reconfiguration message transmitted by the MCG). As another example, the SN may send the TAC command information to the MN using signaling over Xn/X2 and the MN sends the information in a MAC CE to the UE.

Another option for a UE in the dormant state to maintain uplink timing with the SCG is to wait for the timeAlignmentTimer (described above) to expire and then perform RACH on SN to re-establish UL timing (as described above with reference to FIG. 10).

As noted above, the techniques presented herein for maintaining uplink timing in an SCG by a UE in an SCG dormant or SCG deactivated state may allow for quicker transitions of the UE to an SCG activated state. This may be important as there are various delays associated before the network can typically begin scheduling in an SCG activated state (e.g., if uplink timing is not maintained). These include delays due to backhaul signaling between MN and SN to activate SCG, activation signaling to the UE from the MCG (e.g., using DCI, MAC CE, or an RRC reconfiguration message), the UE performing the RACH procedure on the SN and, in the case of deactivated state, and transmitting CQI report. In some cases, upon SN addition, the SCG state can be deactivated, dormant, or activated. In such cases, the state information may be conveyed in RRC reconfiguration message to the UE.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For example, instructions for perform the operations described herein and the appended figures.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. A method for wireless communications by a user equipment (UE), comprising:
receiving an indication to establish uplink timing alignment with at least one secondary node (SN) of a secondary cell group (SCG) of a multi radio access technology (multi-RAT) dual configuration (MR-DC) configuration when the UE is operating in at least one of an SCG deactivated state or an SCG dormant state;
determining whether the UE is in uplink timing alignment with the SN; and
taking one or more actions, upon a determination that the UE is not in uplink timing alignment with the SN, to achieve uplink timing alignment with the SN.

2. The method of claim 1, wherein the one or more actions to acquire uplink timing comprise performing a random access channel (RACH) procedure with the SN.

3. The method of claim 1, wherein:
when the UE is operating in the SCG deactivated state, there is no data transfer between the UE and SN, the UE does not monitor physical downlink control channel (PDCCH) occasions from the SN, and the UE does not provide channel quality indicator (CQI) reports to the SN; and
when the UE is operating in the SCG dormant state, there is no data transfer between the UE and SN, the UE does not monitor PDCCH occasions from the SN, and the UE performs CQI measurements and may provide CQI measurement reports to the SN.

4. The method of claim 1, wherein the indication is provided via signaling, that can originate from the MN or the SN and that is transmitted via the MCG of the MR-DC configuration, to transition from the SCG deactivated state or SCG dormant state to an SCG activated state.

5. The method of claim 4, wherein, when the UE is operating in an SCG activated state, there can be data transfer between the UE and SN.

6. The method of claim 4, wherein the signaling to transition from the SCG deactivated state or SCG dormant state to the SCG activated state comprises at least one of: downlink control information (DCI), a medium access control (MAC) control element (CE), or a radio resource control (RRC) reconfiguration message.

7. The method of claim 1, wherein the indication is provided via a timing advance command (TAC) from the SN, delivered via the MCG when the UE is operating in the SCG dormant state.

8. The method of claim 1, wherein the determination of whether the UE is in the uplink timing alignment with the SN of the SCG is based on:
a first timing alignment timer when the UE is operating in the SCG dormant state; and
a second timing alignment timer when the UE is operating in the SCG deactivated state.

9. The method of claim 8, wherein:
the second timing alignment timer is started upon determining the first timing alignment timer has expired; and
the one or more actions to acquire uplink timing comprise performing a random access channel (RACH) procedure with the SN to acquire uplink timing upon determining the second timing alignment timer has expired.

10. The method of claim 8, further comprising receiving configuration of the second timing alignment timer via at least one of:
a Radio Resource Control (RRC) reconfiguration message transmitted by the SN via the MCG; or
an RRC reconfiguration message transmitted by the SN via the SCG.

11. A method for wireless communications by a network entity configured as a secondary node (SN) of a secondary cell group (SCG) of a multi radio access technology (multi-RAT) dual configuration (MR-DC) configuration for a user equipment (UE), comprising:
configuring the UE with a timing alignment timer for the UE to use to determine a time duration for which UE does not maintain UL timing with the SN when operating in an SCG deactivated state; and
entering the SCG deactivated state or an SCG dormant state.

12. The method of claim 11, wherein the SN configures the UE with the timing alignment timer included in an SN RRC Reconfiguration message conveyed via a master cell group (MCG) of the MR-DC configuration.

13. The method of claim 11, wherein the SN configures the UE with the timing alignment timer included in an SN RRC Reconfiguration message transmitted to the UE directly over the SCG.

14. The method of claim 11, further comprising, upon determining the UE is in need of uplink timing adjustment with the SN in the SCG dormant state, sending the UE a timing adjustment command (TAC).

15. The method of claim 14, wherein the SN sends the TAC via a master cell group (MCG).

16. The method of claim 15, wherein the SN sends the TAC via at least one of:
an SN radio resource control (RRC) reconfiguration message contained with an RRC reconfiguration message transmitted by the MCG; or
timing advance command (TAC) information sent to a master node (MN) of the MCG that triggers the MN to send the TAC to the UE via a medium access control (MAC) control element (CE).

17. The method of claim 14, further comprising determining the UE is in need of uplink timing adjustment with the SN based on channel quality indicator (CQI) reports from the UE.

18. The method of claim 14, further comprising determining the UE is in need of uplink timing adjustment with the SN by monitoring a timing alignment timer for the UE.

19. A method for wireless communications by a network entity configured as a master (MN) of a master cell group (MCG) of a multi radio access technology (multi-RAT) dual configuration (MR-DC) configuration for a user equipment (UE), comprising:
receiving a configuration of a timing alignment timer for the UE to use to determine a time duration for which UE does not maintain UL timing with a secondary node (SN) of a secondary cell group (SCG) when the UE is operating in an SCG deactivated state with the UE; and
configuring the UE with the timing alignment timer.

20. The method of claim 19, wherein the MN configures the UE with the timing alignment timer via a radio resource configuration (RRC) reconfiguration message.

21. The method of claim 19, further comprising:
receiving, from the SN, a timing adjustment command (TAC); and
conveying the TAC to the UE.

22. The method of claim 21, wherein the MN conveys the TAC to the UE via a radio resource control (RRC) reconfiguration message.

23. The method of claim 21, wherein the MN conveys the TAC to the UE via a medium access control (MAC) control element (CE).

24.-29. (canceled)
